(19) United States
(12) Patent Application Publication
(10) Pub. No.: US 2018/0165695 A1
(43) Pub. Date: Jun. 14, 2018

(54) DETERMINING DENSITY OF CUSTOMERS BASED ON WI-FI LOAD

(71) Applicant: Wal-Mart Stores, Inc., Bentonville, AR (US)

(72) Inventors: Nicholaus A. Jones, Fayetteville, AR (US); Robert J. Taylor, Rogers, AR (US); Aaron J. Vasgaard, Rogers, AR (US); Matthew A. Jones, Bentonville, AR (US)

(21) Appl. No.: 15/832,029

(22) Filed: Dec. 5, 2017

Related U.S. Application Data
(60) Provisional application No. 62/433,171, filed on Dec. 12, 2016.
(60) Provisional application No. 62/433,174, filed on Dec. 12, 2016.

(51) Int. Cl. G06Q 30/02; H04W 4/02; H04W 24/08

(52) U.S. Cl. CPC G06Q 30/0201; H04W 4/021; H04W 24/08; H04W 4/023

(57) ABSTRACT

In some embodiments, apparatuses and methods are provided herein useful to the determination of customer density patterns in a shopping facility using a wireless access point. In some embodiments, there is provided a system for determining customer density patterns in a shopping facility including: a wireless access point accessible by network enabled user devices and having a coverage zone in a shopping facility; and a control circuit coupled to the wireless access point and configured to: receive data corresponding to wireless traffic at the wireless access point; process the data to determine a load of the wireless access point; estimate, based on the load over a period of time, a customer density pattern in the coverage zone at a point in time within the period of time; and output a signal to take an action based on at least the estimated customer density pattern in the coverage zone.

### CROSS-REFERENCE TO RELATED APPLICATION

This application claims the benefit of U.S. Provisional Application No. 62/433,171, filed Dec. 12, 2016, and U.S. Provisional Application No. 62/433,174, filed Dec. 12, 2016, which are incorporated herein by reference in their entirety.

### TECHNICAL FIELD

This invention relates generally to detecting a number of customers in a shopping facility, and more particularly, to detecting the number of customers in a shopping facility having wireless access points.

### BACKGROUND

In the retail setting, a first portion of an area of the shopping facility may experience heavy customer traffic while a second portion of the area may not have customer traffic or may have light customer traffic. The ebbs and flows of customer traffic varies at particular times of particular days. For example, a long customer line forms at one register while another register that is located at another area of the shopping facility does not have a line or has a couple of customers in line. A customer in line at the first register may get frustrated due to delay caused by the heavy customer traffic and may end up leaving the shopping facility due to the long line. Unknown to the customer, the second register that is located at another area of the shopping facility is not busy at all. Thus, lack of information regarding density of customers in particular areas in the shopping facility creates inefficiency in managing the shopping facility and causes frustrations from the customers. Frustrations of the customer may lead to possible loss of sale for the shopping facility. So, it would be desirable to know the density of customers in one or more locations in the shopping facility to alleviate, mitigate, and/or eliminate problems or issues resulting from management inefficiency and poor resource planning.

### BRIEF DESCRIPTION OF THE DRAWINGS

Disclosed herein are embodiments of systems, apparatuses and methods pertaining to detection of a number of customers using one or more wireless access points in a shopping facility. This description includes drawings, wherein:

FIG. 1 is a block diagram of an exemplary representation of a system for determining customer density patterns in a shopping facility, where a wireless access point is associated with a zone of coverage in accordance with some embodiments;

FIGS. 2 and 3 illustrate an exemplary flow diagram of a process for determining customer density patterns in the shopping facility in accordance with several embodiments;

FIG. 4 is a block diagram of an exemplary representation of a system for determining customer density patterns in a shopping facility, where a particular wireless access point is accessed by a particular network enabled user device in accordance with some embodiments;

FIG. 5 is an exemplary flow diagram of a process for determining customer density patterns as may be used in the system of FIG. 4 in accordance with some embodiments; and

FIG. 6 shows a chart of an exemplary customer density pattern estimated for a period of time.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for detection of a number of customers using wireless access point in a shopping facility. In some embodiments, there is provided a system for estimating customer density in a shopping facility including a control circuit coupled to a wireless access point that is accessible by network enabled user devices, where the wireless access point is associated with a coverage zone in a shopping facility. The control circuit may receive data corresponding to wireless traffic at the wireless access point and process the data to determine a load of the wireless access point. The control circuit may also estimate, based on the load over a period of time, a customer density pattern in the coverage zone at a point in time within the period of time and output a signal to take an action based on at least the estimated customer density pattern in the coverage zone.

In some embodiments, there is provided a method for estimating customer density in a shopping facility including receiving data from a wireless access point corresponding to wireless traffic at the wireless access point. The wireless access point being accessible by network enabled user devices and having a coverage zone in the shopping facility. The method may also include processing the data, using a control circuit, to determine a load of the wireless access point; estimating, using the control circuit, a customer density pattern in the coverage zone at a point in time within a period of time based on the load over the period of time; and outputting a signal to take an action based on at least the estimated customer density pattern in the coverage zone.

Furthermore, generally speaking, pursuant to various embodiments, systems, apparatuses and methods are provided herein useful for detection of a number of customers using wireless access point in a shopping facility. In some embodiments, there is provided a system for estimating customer density in a shopping facility including a control circuit coupled to a first wireless access point and a second wireless access point. The first wireless access point accessible by network enabled user devices and having a first coverage zone. The second wireless access point only accessible by workers of a shopping facility and having a second coverage zone that overlaps at least a part of the first coverage zone. The control circuit may receive data corresponding to wireless traffic at the first wireless access point and the second wireless access point. The control circuit may also identify wireless traffic at the first wireless access point that corresponds to wireless traffic at the second wireless access point. The control circuit may process the data to estimate a customer density in the first coverage zone by at least subtracting from the wireless traffic at the first wireless access point the wireless traffic that corresponds to the wireless traffic at the second wireless access point and output signaling to take an action based on the estimated customer density in the first coverage zone.

In some embodiments, there is provided a method for estimating customer density in a shopping facility including receiving data corresponding to wireless traffic at a first wireless access point and a second wireless access point. The first wireless access point is accessible by network enabled user devices and having a first coverage zone. The second wireless access point is only accessible by workers of the shopping facility and having a second coverage zone that overlaps at least a part of the first coverage zone. The method may also include identifying wireless traffic at the first wireless access point that corresponds to wireless traffic at the second wireless access point. The method may also include processing the data to estimate a customer density in the first coverage zone by at least subtracting from the wireless traffic at the first wireless access point the wireless traffic that corresponds to the wireless traffic at the second wireless access point. The method may including outputting signaling to take an action based on the estimated customer density in the first coverage zone.

Systems and methods are disclosed that detect a number of customers based at least on a load, e.g., Wi-Fi load, of one or more wireless access points in a shopping facility. The load in an area of the shopping facility may be tracked over time. The area may correspond to a zone or a coverage zone. In some embodiments, a density of customers corresponding to one or more areas of the shopping facility may be ascertained to estimate customer flow within the shopping facility at a particular time of a particular day. In some embodiments, changes to tracked load may also be ascertained to further determine or estimate the customer flow. In some embodiments, information resulting from the detection of the number of customers are used to coordinate with point-of-sale (POS) data, resource planning, feature planning, and customer service enhancement to improve sales, efficiency and customer satisfaction in the shopping facility.

In one or more embodiments, a system may include the one or more wireless access points distributed throughout one or more sales floors in the shopping facility. A coverage area or region, e.g., Wi-Fi coverage, of each of the wireless access points may be defined as a zone. In some embodiments, the density of customers in the one or more sales floors may be estimated from the load on each of wireless access points assigned to a particular zone. In some embodiments, changes in loads on the one or more wireless access points may be used to determine or estimate the flow of customers in one or more directions. In an example, the wireless access points may track movement of customers from one zone to another zone. Further, in some embodiments, detection of a load exceeding a threshold may indicate a need for additional customer support (e.g., a cash registers) in a particular zone. The threshold may include one or more predetermined thresholds.

In some embodiments, a system for determining customer density in a shopping facility includes a first wireless access point accessible by network enabled user devices and having a first coverage zone. In one configuration, the system may include a second wireless access point only accessible by workers of a shopping facility and has a second coverage zone that overlaps at least a part of the first coverage zone. In another configuration, the system may include a control circuit coupled to the first and second wireless access points. By one approach, the control circuit may receive data corresponding to wireless traffic at the first wireless access point and the second wireless access point. By another approach, the control circuit may identify wireless traffic at the first wireless access point that corresponds to wireless traffic at the second wireless access point. By another approach, the control circuit may process the data to estimate a customer density in the first coverage zone by at least subtracting from the wireless traffic at the first wireless access point the wireless traffic that corresponds to the wireless traffic at the second wireless access point. By yet another approach, the control circuit may output signaling to take an action based on the estimated customer density in the first coverage zone.

In one example, the customer density may be estimated based on customer load of the first wireless access point over a period of time. In such an example, the control circuit may estimate a customer density pattern in the first coverage zone based on the estimated customer load. By one approach, the control circuit may compare the estimated customer density pattern in the first coverage zone to point of sale data to determine if the estimated customer density pattern in the coverage zone is justified by the point of sale data.

In another example, the control circuit may estimate a plurality of customer density patterns in a plurality of coverage zones based on the estimated customer load. In such an example, the control circuit may track customer flow in one or more directions based on changes in the estimated plurality of customer density patterns. In one configuration, the control circuit may automatically create a task in a task scheduling system in response to the estimated customer density in the first coverage zone. In another configuration, a worker in the shopping facility may be alerted when the estimated customer density in the first coverage zone exceeds a predetermined threshold. In another configuration, the control circuit may determine a duration that the estimated customer density in the first coverage zone remains above the predetermined threshold. In such configuration, the control circuit may output a signal to take an action when the duration exceeds the predetermined duration.

In another example, the system may include a first plurality of wireless access point having a first plurality of coverage zones and positioned throughout the shopping facility. By one approach, the first plurality of wireless access point may include the first wireless access point. By another approach, the system may include a second plurality of wireless access point that may be only accessible by the workers of the shopping facility. In one configuration, the second plurality of wireless access point may have a second plurality of coverage zones that overlaps at least a part of the first plurality of coverage zones. In one scenario, the second plurality of wireless access point may include the second wireless access point.

In another configuration, at least one of the first plurality of coverage zones or the second plurality of coverage zones may be minimally overlapping coverage zones. By one approach, the control circuit may track a customer leaving the first coverage zone and entering the second coverage zone. By another approach, the control circuit may be coupled to at least one of at least one point-of-sale (POS) system; a task scheduling system; an inventory system; a database; a storage system; and/or an employee management system via a network.

In yet some embodiments, a method for determining customer density patterns in a shopping facility includes, at a control circuit coupled to a first wireless access point and a second wireless access point, receiving data corresponding to wireless traffic at the first wireless access point and the second wireless access point. By one approach, the first wireless access point may be accessible by network enabled user devices and has a first coverage zone. By another approach, the second wireless access point may be only accessible by workers of the shopping facility and has a second coverage zone that overlaps at least a part of the first coverage zone. By another approach, the method may include identifying wireless traffic at the first wireless access point that corresponds to wireless traffic at the second wireless access point. In one configuration, the method may include processing the data to estimate a customer density in the first coverage zone by at least subtracting from the wireless traffic at the first wireless access point the wireless traffic that corresponds to the wireless traffic at the second wireless access point. In yet another configuration, the method may include outputting signaling to take an action based on the estimated customer density in the first coverage zone.

In one configuration, the customer density may be estimated based on customer load of the first wireless access point over a period of time. By one approach, the method may include estimating a customer density pattern in the first coverage zone based on the estimated customer load. By another approach, the method may include comparing the estimated customer density pattern in the first coverage zone to point of sale data to determine if the estimated customer density pattern in the coverage zone is justified by the point of sale data. By another approach, the method may include estimating a plurality of customer density patterns in a plurality of coverage zones based on the estimated customer load. In one configuration, the method may include tracking customer flow in one or more directions based on changes in the estimated plurality of customer density patterns. In another configuration, the method may include automatically creating a task in a task scheduling system in response to the estimated customer density in the first coverage zone. In one configuration, the method may include alerting a worker in the shopping facility when the estimated customer density in the first coverage zone exceeds a predetermined threshold. By one approach, the method may include determining a duration that the estimated customer density in the first coverage zone remains above the predetermined threshold. In another configuration, the method may include outputting a signal to take an action when the duration exceeds the predetermined duration. In one example, the method may include tracking a customer leaving the first coverage zone and entering the second coverage zone. By one approach, the control circuit may be coupled to at least one of a point-of-sale (POS) system including point of sale data; a task scheduling system, an inventory system; a database, a storage system, and/or an employee management system. In one configuration, the first wireless access point may correspond to a wireless public access point. In another configuration, the second wireless access point may correspond to a wireless secure access point.

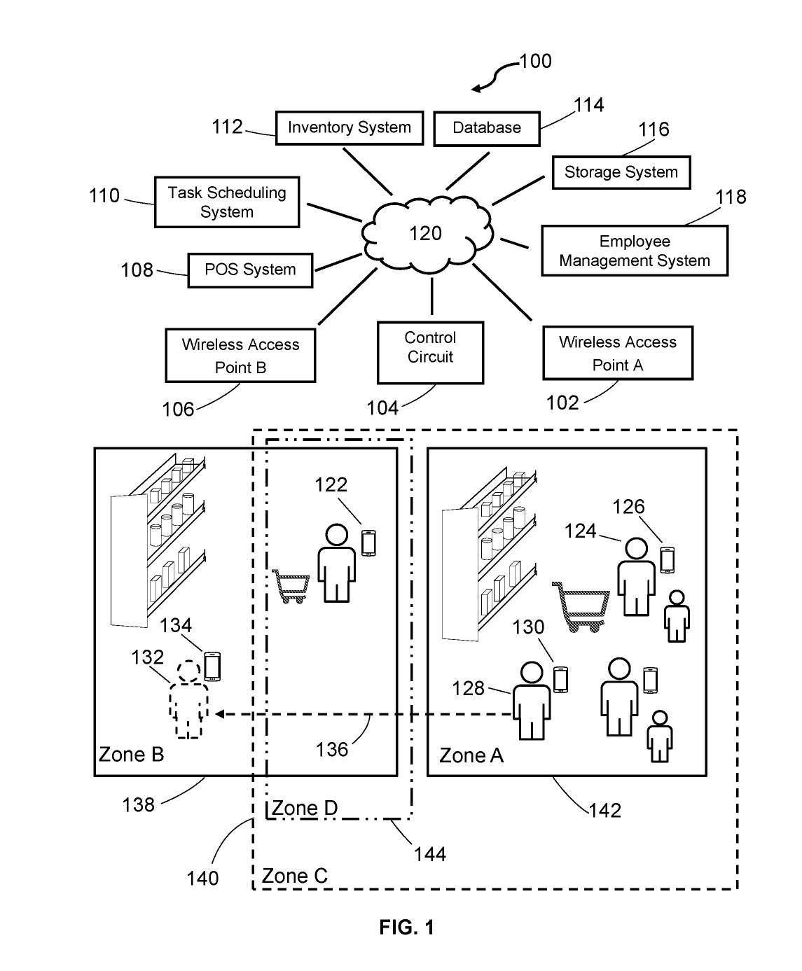

Reference will now be made to FIG. 1 which shows a block diagram of an exemplary representation of a system 100 for use in estimating customer density in a shopping facility. The system 100 includes a control circuit 104 coupled to a wireless access point A 102. The system 100 may also include a wireless access point B 106, which may be coupled to the control circuit 104. The control circuit 104 may be directly coupled to at least one of the wireless access point A 102 or the wireless access point B 106. By one approach, one or more wireless access points, in addition to the wireless access point A 102 or the wireless access point B 106, may be positioned throughout the shopping facility. The one or more wireless access points may have a plurality of coverage zones. By one configuration, the plurality of coverage zones are minimally overlapping coverage zones. By another approach, the system 100 may also include at least one of point-of-sale (POS) system 108, a task scheduling system 110, an inventory system 112, a database 114, a storage system 116, and an employee management system 118.

The wireless access point A 102 or the wireless access point B 106 may include any device that enables a wireless device or node to connect to a network 120. The wireless access point A 102 or the wireless access point B 106 are coupled to the network 120. The wireless access point A 102 and/or the wireless access point B 106 may include a router, a modem, or any combination thereof. A wireless device communicating with the wireless access points may include network enabled user device 122, network enabled user device 126, network enabled user device 130, or network enabled user device 134. In some embodiments, the wireless access points are described as Wi-Fi access points and the wireless devices are described as Wi-Fi enabled devices, as of which are configured to communicate according to one or more of the various well understood Wi-Fi communication standards, such as IEEE 802.11n. It is understood that wireless communications and devices using Wi-Fi standards are exemplary, and that the devices described herein may communicate according to any known or future wireless communication protocol.

The wireless access point A 102 may be accessible to the one or more network enabled user devices 122, 126, 130, 134 (all of which are examples of wireless devices that may communicate with the wireless access points, such as Wi-Fi enabled wireless devices). The wireless access point A 102 has a particular coverage zone in the shopping facility. The wireless access point A 102 may have coverage for at least one of zone A 142, zone B 138, or zone C 140. The zone C 140 includes the zone A 142. The zone C 140 overlaps a portion of the zone B 138. The zone A 142 does not overlap any portion of the zone B 138.

The wireless access point B 106 may also have coverage for at least one of the zone A 142, zone B 138, or the zone C 140. The wireless access point B 106 may be accessible to the one or more network enabled user devices 122, 126, 130, 134. In an example, the wireless access point A 102 has coverage over the zone A 142 and accessed by the network enabled user devices 126, 130 located in the zone A 142. However, the wireless access point A 102 may also be accessed by the network enabled user devices 122, 134 that are located in the zone B 138, where the zone B 138 is covered by the wireless access point B 106. Specifically, wireless traffic generated by the network enabled user devices 126, 130 corresponds to wireless traffic at the wireless access point A 102, while wireless traffic generated by the network enabled user devices 122, 134 corresponds to wireless traffic at the wireless access point B 106.

The control circuit 104 may receive data corresponding to at least one of the wireless traffic at the wireless access point A 102 or the wireless access point B 106. The received data may be stored at the storage system 116. The storage system 116 may also be accessed by at least one of the POS system 108, the task scheduling system 110, the inventory system 112, the database 114, or the employee management system 118. The storage system 116 may include one or more storage devices, where at least one of the storage devices is internal to at least one of the POS system 108, the task scheduling system 110, the inventory system 112, the database 114, or the employee management system 118.

The data may be processed at the control circuit 104 to determine a load of at least one of the wireless access point A 102 or the wireless access point B 106 over a period of time. A customer density pattern in a coverage zone (the zone A 142, the zone B 138, or the zone C 140) at a point in time within the period of time monitored may be estimated at the control circuit 104. In some embodiments, one or more signals are output by the control circuit 104 based on at least the estimated customer density pattern in the coverage zone. The one or more signals are associated with one or more actions. By way of example, the one or more actions may include directing one or more workers of the shopping facility to ensure that customers are taken care off, alleviate long lines at checkout counter or customer service, order more products associated with one or more shelves, correlate estimated customer density pattern to sales data associated with the POS system 108, or any combination thereof. The one or more actions may also include directing the one or more workers of the shopping facility to restock shelves or clean up when customer traffic is low.

In another implementation, the control circuit 104 may identify that a portion of the wireless traffic at the wireless access point A 102 corresponds to the wireless traffic at the wireless access point B 106. For example, the network enabled user devices 122, 126, 130 are located in the zone C 140. The wireless access point B 106 may be configured to provide coverage in the zone B 138, where the network enabled user devices 122, 134 are located. However, the wireless access point A 102 is accessed by the network enabled user device 122.

In another implementation, the control circuit 104 may determine that there are one or more overlaps in coverage zones. For example, the control circuit 104 may determine that the network enabled user device 122 may access the wireless access point A 102 and the wireless access point B 106. In response to the determination, the control circuit 104 may create a zone D 144 to remove an overlap and to provide refined coverage zones to estimate customer density. As such, for example, the network enabled user device 122 may be located in the zone D 144, the network enabled user device 126 may be located in the zone A 142, and the network enabled user device 134 may be located in the zone B 138. Thus, the control circuit 104 may refine coverage zones to estimate customer density and/or to provide customer service to a more defined area.

The control circuit 104 may identify that the wireless data associated with the network enabled user devices 126, 130 corresponds to the wireless traffic at the wireless access point A 102. The control circuit 104 may remove or subtract the portion of the wireless traffic at the wireless access point A 102 that corresponds to the wireless traffic at the wireless access point B 106 (i.e. wireless traffic generated by the network enabled user device 122) to determine an estimated customer load of the wireless access point A 102. The control circuit 104 may also estimate a customer density pattern in a first coverage zone at a point in time within a period of time being monitored. For example, the control circuit 104 estimates the customer density pattern in the zone A 142. In one implementation, the customer density pattern in the zone A 142 may be estimated based on at least one of the load of the wireless access point A 102 or a change in density of customers in the zone A 142 over a period of time.

In some embodiments, in response to the estimated customer density pattern in the zone A 142, the control circuit 104 may automatically create a task in the task scheduling system 110. In another implementation, the control circuit 104 may alert a worker of the shopping facility when an estimated density of the customers in the zone A 142 exceeds a predetermined threshold. The control circuit 104 may determine that a duration of the estimated density of the customers in the zone A 142 remains above the predetermined threshold. The control circuit 104 may also output a signal to take an action when the duration exceeds the predetermined duration.

In another implementation, the control circuit 104 may compare the estimated customer density pattern in the zone A 142 to point of sale data in the POS system 108 to determine if the estimated customer density pattern in the zone A 142 is justified or verified by the point of sale data. For example, the control circuit 104 may compare whether the estimated customer density pattern in the zone A 142 correlates with the corresponding sales data in the POS system 108. The POS system 108 may include the sales data generated in various checkout counters in the shopping facility. The POS system 108 may also communicate the sales data to the database 114 and the inventory system 112. By one approach, the control circuit 104 may be coupled to the at least one of: the POS system 108, the POS system comprising point of sale data; the task scheduling system 110; the inventory system 112; the database 114; the storage system 116; or the employee management system 118 via the network 120.

In another implementation, the control circuit 104 may track a customer leaving one coverage zone associated with one wireless access point and entering a neighboring coverage zone associated with a neighboring wireless access point. For example, customers 124, 128 are located, at a first time, in the zone A 142 of the wireless access point A 102. The customers 124, 128 are tracked and identified by the control circuit 104 as being located in the zone A 142. At a second time, the customer 128 moved 136 from the zone A 142 to the zone B 138. The control circuit 104, at the second time, may track the movement 136 and identify that the customer 128 in the zone A 142 is now identified as the customer 132 in the zone B 138 of the wireless access point B 106. It is understood by an ordinary person skilled in the art that customers move from one coverage zone to another coverage and vice versa, such as from the zone B 138 to the zone A 142 or from the zone A 142 to the zone B 138.

In another embodiment, the control circuit 104 may determine that the network enabled user device 122 belongs to the worker of the shopping facility based on the employee management system 118. The employee management system 118 includes data associated with the workers of the shopping facility. The data associated with the workers may include media access control (MAC) addresses of Wi-Fi devices that belong to the workers of the shopping facility.

The term control circuit as used herein refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 104 may be configured (for example, by using corresponding programming stored in a memory as will be well understood by those skilled in the art) to carry out one or more of the steps, actions, and/or functions described herein.

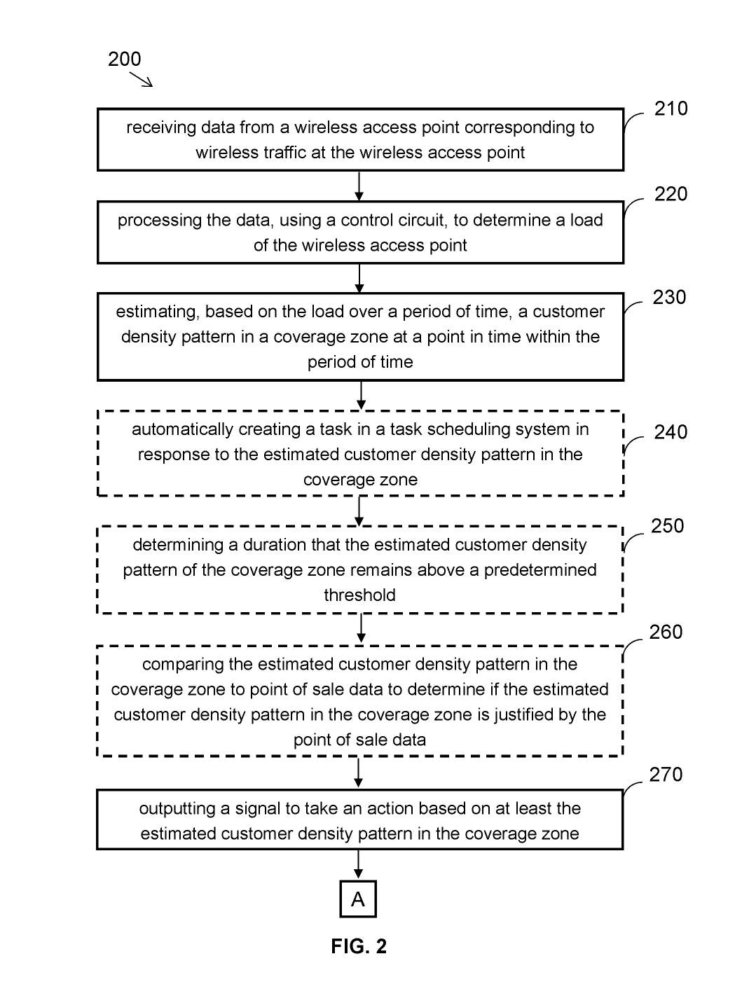

FIG. 2 illustrates an exemplary flow diagram of an exemplary method 200 of estimating a customer density in the shopping facility in accordance with some embodiments. The exemplary method 200 may be implemented in the system 100 of FIG. 1 or other systems. At step 210, data is received from a wireless access point corresponding to wireless traffic at the wireless access point, the data received over a period of time. For example, the control circuit 104 of FIG. 1 may receive data from the wireless access point A 102 of FIG. 1 or the wireless access point B 106 of FIG. 1. The received data may correspond to the wireless traffic generated by the at least one of the network enabled user devices 122, 126, 130, 134 of FIG. 1. Such data may include active data from established communication sessions between the respective wireless access point and the respective user devices including any address or identification of the device and all data traffic between the devices. Such data may also include any communication or signaling between the respective wireless access point and the respective user devices where an active communication session or link is not established, but where initial communications are exchanged that may or may not result in a communication link or connection being established. In either case, the wireless access point obtains data about a number of devices in its range that it may connect with. It will indeed connect with some, but not with all. It is well known in accordance with at least the Wi-Fi standard that at least minimal signaling is automatically exchanged between a Wi-Fi wireless access point and a Wi-Fi enabled wireless user device in the range of the access point, even if ultimately, the user device does not join the network.

In step 220, the received data is processed using the control circuit to determine a load of the wireless access point. The load may be associated with the wireless traffic generated by the at least one of the network enabled user devices 122, 126, 130, 134 of FIG. 1. By one approach, the load associated with the wireless traffic may be associated with a number of wireless devices detected by the wireless access point at a particular coverage zone during a period of time. By another approach, the wireless traffic may be, alternatively or in addition to, associated with volume of traffic handled by the wireless access point at the particular coverage zone during the period of time. The volume of traffic, for example, may be estimated based on cumulative amount of data bandwidth used or average data rate of the wireless devices during the period of time.

In step 230, a customer density pattern in a coverage zone is estimated based on the load of the wireless access point at a point in time within a period of time being monitored. The coverage zone may correspond to at least one of the zone A 142, the zone B 138, or the zone C 140. For example, at the wireless access point B 106, the control circuit 104 may determine data bandwidth used, number of network enabled user devices detected in Zone B 138, data rate associated with the number of network enabled user devices, and/or corresponding data associated with the wireless access point A 406 and/or Zone A 142 and/or Zone C 140 for a time period to estimate a customer density pattern. By another approach, the data bandwidth used, the number of network enabled user devices detected, the data rate associated with the number of network enabled user devices may be average numbers calculated and/or extrapolated from previous calculation by the control circuit 104 for the time period and/or other similar time periods. The detection of the number of network enabled user devices may be based on signaling communications received by the wireless access point B 106 and/or the wireless access point A 102 during the time period.

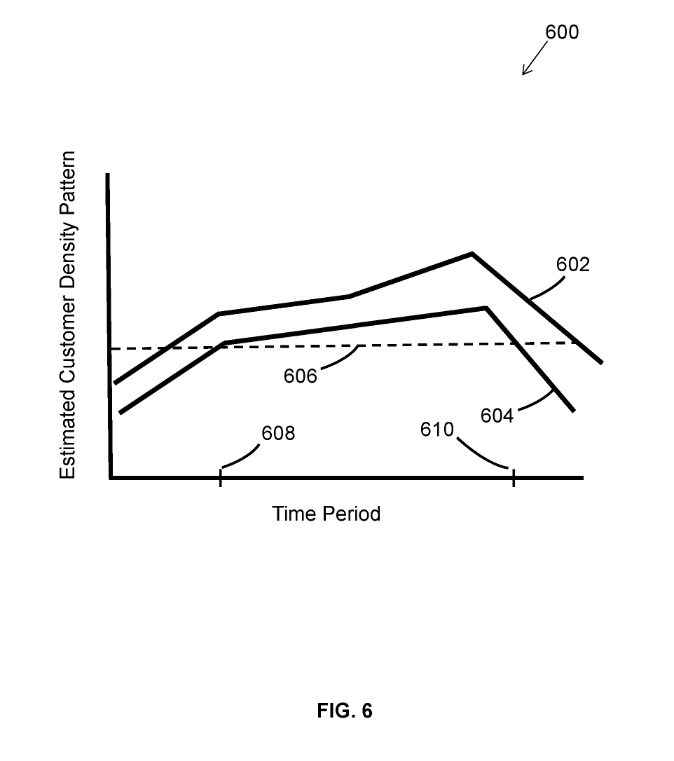

By way of example, FIG. 6 shows a chart 600 illustrating an exemplary customer density pattern estimated by the control circuit 104 over a particular period of time. A first customer density pattern 602 may be estimated over a first day. A second customer density pattern 604 may be estimated over a second day. In one configuration, the first customer density pattern 602 and/or the second customer density pattern 604 may be estimated based on at least one of the data bandwidth used, the number of network enabled user devices detected in Zone B 138, the data rate associated with the number of network enabled user devices, and/or the corresponding data associated with the wireless access point A 406 and/or Zone A 142 and/or Zone C 140 for a time period between a first time 608 and a second time 610.

As an example, the first customer density pattern 602 may correspond to a customer density pattern being estimated on Wednesday between 9 AM to 5 PM while the second customer density pattern 604 may correspond to a customer density pattern being estimated on Friday between 9 AM to 5 PM. As another example, a customer density pattern may be estimated, for example, every Wednesday and every Friday for three consecutive months. By one approach, the first and second customer density patterns 602, 604 may each be a resulting pattern from averaging two or more of the estimated customer density patterns at a particular day over a particular time period. For example, the first customer density pattern 602 may correspond to averaging all of the customer density patterns estimated every Wednesday for three consecutive months; while the second customer density pattern 604 may correspond to averaging all of the customer density patterns estimated every Friday for three consecutive months. As can be seen, a customer density profile taken over a period of time can be useful to identify points in time or periods in time within the density profile where customer density in the coverage zone is relatively high or low. These peaks and lows in customer density may or may not correspond to normal expected high and low expected traffic in the store. For example, during a period of high sales (e.g., weekend afternoon), the wireless load from a coverage zone may reveal the expected high customer density or may not. This can allow the retailer to automatically map areas within the retail facility where there are high and low customer density at a higher resolution than simply taking gross sales or other measures of customer traffic. For example, customer density profiles may reveal during an expected period of high customer traffic that certain coverage areas (e.g., corresponding to certain departments) are busy while others are not. That is, in some embodiments, customer density profiles taken over time can be useful to assess customer density at specific point in time or specific periods of time within a larger periods of time.

By one approach, the control circuit 104 may determine based on the first and second customer density patterns 602, 604 that one or more associates or workers are needed at a particular area of a retail store at a certain time (e.g., between 3 PM to 4 PM) to assist customers. Similarly, based on wireless access point load, the control circuit can identify from the customer density profiles times for areas in the store that have a low density making it easier for workers to perform certain tasks such as cleaning, restocking, etc. Thus, the control circuit 104 may send notification to the employee management system 118 of FIG. 1 to direct the one or more associates to the particular area of the retail store to accomplish these and other functions. In another implementation, a task is automatically created in a task scheduling system in response to the estimated customer density pattern in the coverage zone, at step 240. The task scheduling system may correspond to the task scheduling system 110.

At step 250, a duration is determined whether the estimated customer density pattern of the coverage zone remains above a predetermined threshold. For example, the control circuit 104 may determine that the first and second density patterns 602, 604 of FIG. 6 are above a predetermined threshold 606 during a duration between the first time 608 of a time period and the second time 610 of the time period. In one configuration, the control circuit 104 may correlate the first and second density patterns 602, 604 with sales data of the POS system 108 of FIG. 1 for the time period corresponding to the first and second times. The control circuit 104 may determine based on the correlation that one or more cashiers are needed to meet a higher number of customers between the first time 608 and the second time 610.

In another implementation, at step 260, the estimated customer density pattern in the coverage zone is compared to point of sale data to determine if the estimated customer density pattern in the coverage zone is justified or verified by the point of sale data. The point of sale data may correspond to sales data in the POS system 108. By way of example, the POS system 108 may store sales data for a period of time. The control circuit 104 may receive the sales data from the POS system 108 and, based on the received sales data, determine sales volume for a particular time period. The control circuit 104 may compare the sales volume to the estimated customer density pattern for the particular time period to verify an increase, decrease, or plateau of the estimated customer density pattern in the coverage zone.

Moreover, the point of sale data is correlated with the estimated customer density pattern and determine whether there is a correlation of sale of one or more products to the estimated customer density pattern. By one approach, a signal to take action, at step 270, is output based on at least the estimated customer density pattern in the coverage zone. The signal may be output by the control circuit 104 of FIG. 1 to at least one of the POS system 108, the task scheduling system 110, the inventory system 112, or the employee management system 118 of FIG. 1. For example, the signal may be sent to the task scheduling system 110 to restock a shelf in aisle 1 with product A at a first time, product B at a second time, and product C at a third time. The signal may be communicated with the employee management system 118 to identify the one or more workers available to restock the shelf at the specified time.

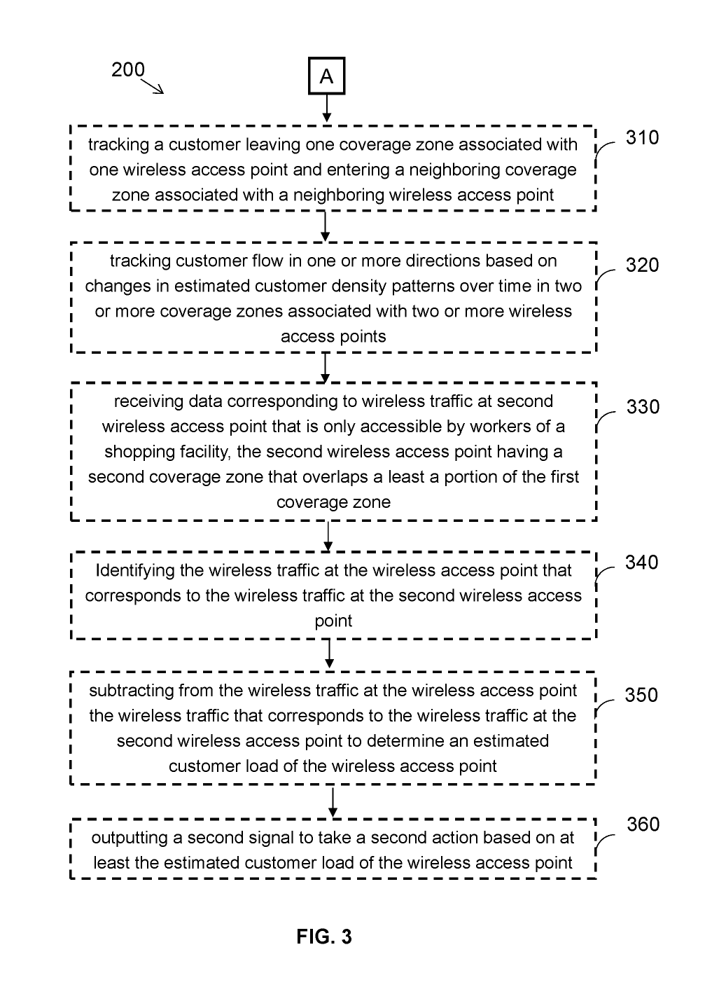

FIG. 3 illustrates a continuation of the flow diagram in FIG. 2. At step 310, tracking a customer leaving one coverage zone associated with one wireless access point and entering a neighboring coverage zone associated with a neighboring wireless access point. For example, the customer 128 of FIG. 1 was initially at the zone A 142 associated with the wireless access point B 106. The customer 128 is indicated as the customer 132 when he moved to the zone B 138 at a particular time, where the zone B 138 is associated with the wireless access point A 102. The control circuit 104 tracked the movement 136 from the zone A 142 to the zone B 138. The zone A 142 is associated with the wireless access point A 102. The zone B 138 is associated with the wireless access point B 106. For example, the control circuit 104 gets data, at a first time, indicating that a wireless device (e.g., the device operated by customer 128) was in range of the wireless access point covering zone A, then, at a second time, gets data indicating that the same wireless device is now in range of the wireless access point covering zone B. Based at least on this information, the control circuit can estimate or infer that the customer associated with that wireless device has moved from zone A to zone B. Similar tracking can occur among multiple devices to estimate travel movements.

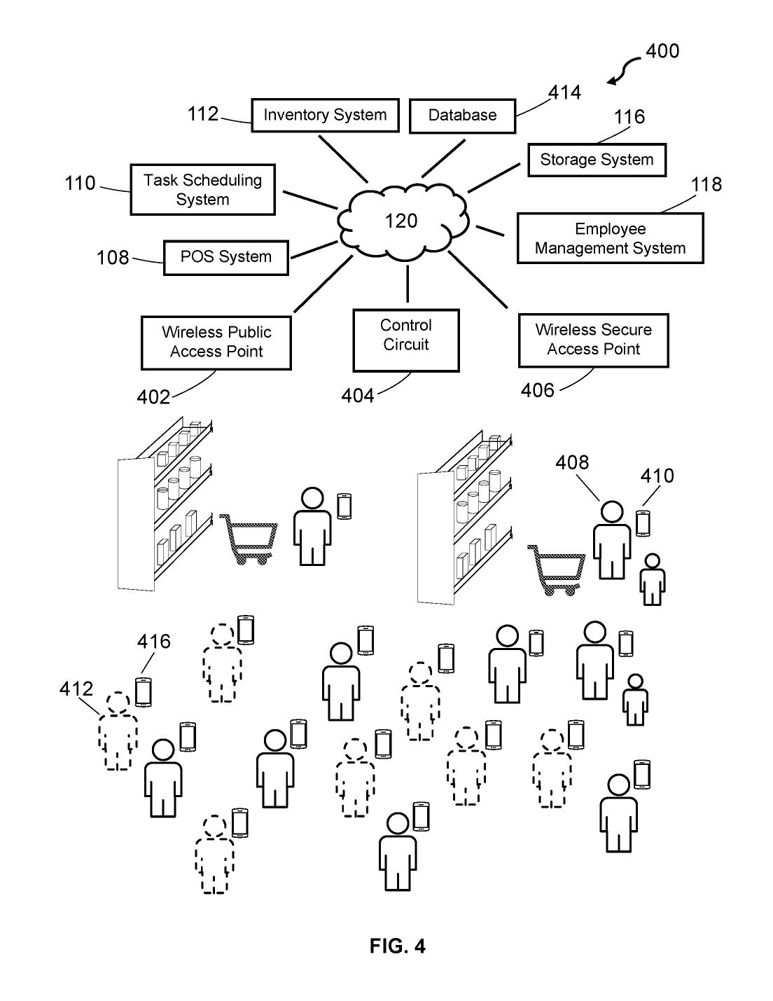

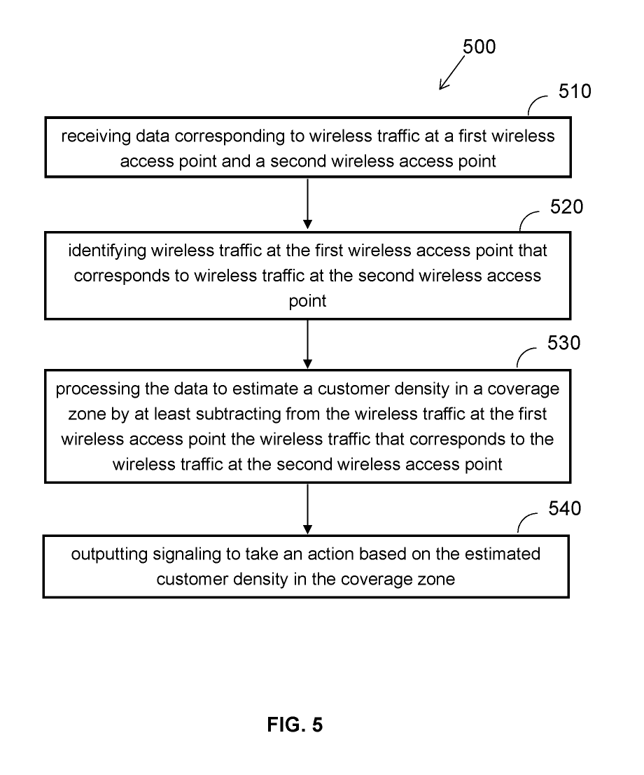

At step 320, customer flow is tracked in one or more directions based on changes in estimated customer density patterns over time in two or more coverage zones associated with two or more wireless access points. Customers at the shopping facility may move from the zone B 138 to the zone A 142 and back to the zone B 138. The control circuit 104 may track these movements. In another implementation, data is received that corresponds to wireless traffic at second wireless access point that is only accessible by workers of a shopping facility, at step 330. See further details for these embodiments below in the discussion of FIGS. 4-5. The second wireless access point has a second coverage zone that overlaps a least a portion of the first coverage zone. In an embodiment, the wireless access point B 106 may correspond to the second wireless access point that is only accessible by the workers of the shopping facility. At step 340, the wireless traffic at the wireless access point that corresponds to the wireless traffic at the second wireless access point is identified. The control circuit 104 may identify the wireless traffic at the wireless access point B 106. The wireless traffic may correspond to the wireless data generated by the network enabled user devices 122, 126, 130, 134 of FIG. 1.

The control circuit 104 may subtract from the wireless traffic at the wireless access point the wireless traffic that corresponds to the wireless traffic at the second wireless access point to determine an estimated customer load of the wireless access point, at step 350. By one approach, the wireless traffic may correspond to a number of wireless devices detected by the wireless access point at a particular coverage zone during a period of time. By another approach, the wireless traffic may, alternatively or in addition to, correspond to volume of traffic handled by the wireless access point at the particular coverage zone during the period of time. The volume of traffic, for example, may be estimated based on cumulative amount of data bandwidth used or average data rate of the wireless devices during the period of time.

For example, the wireless traffic associated with the network enabled user devices 122, 126, and 130 are received by the wireless access point A 102. However, the network enabled user device 122 is located in the zone B 138 and, thus, within the area of coverage by the wireless access point B 106. The control circuit 104 may subtract the wireless traffic associated with the network enabled user device 122 from the wireless traffic at the wireless access point A 102 to determine the estimated customer load of the wireless access point A 102. The control circuit 104 may store in the storage system 116 and the database 114 a plurality of device numbers associated with a plurality of network enabled user devices that accesses at least one of the wireless access point A 102 or the wireless access point B 106. At step 360, a second signal to take a second action is output based on at least the estimated customer load of the wireless access point. The control circuit 104 may send the second signal to the employee management system 118 indicating that customer support is needed in a particular aisle in the zone B 138.

Referring to FIG. 4, an embodiment of a system 400 for estimating customer density in a shopping facility is illustrated. The system 400 includes a control circuit 404, a wireless public access point 402, and a wireless secure access point 406. The wireless public access point 402 is configured to be accessible by a plurality of network enabled user devices associated with a plurality of customers of the shopping facility. That is, the wireless public access point 402 does not have security or password limitation or otherwise allows the wireless device of any public or shopping customer to access the wireless public access point 402. Such customers may still need to enter information and/or a known password and/or otherwise accept certain terms to establish a connection with the wireless public access point 402, but it is considered to be freely connectable to any wireless device.

For example, as illustrated, customer 408 of the plurality of customers of the shopping facility is associated with a network enabled user device 410. The network enabled user device 410 may access the wireless public access point 402. In some embodiments, the network enabled user device 410 may not access the wireless secure access point 406. The wireless secure access point 406 may only be accessed by a plurality of workers of the shopping facility. Accessing the wireless secure access point 406 requires authorization to access, which may be provided through the user of non-public login and password, device registration, and/or other known ways to allow for secure access to the wireless secure access point 406. The authorization to access may be determined based on the employee management system 118. The employee management system 118 may communicate with the database 414 to determine identifications of the plurality of network enabled user devices corresponding to the plurality of workers of the shopping facility. For example, information regarding a network enabled user device 416 corresponding to worker 412 are stored in the storage system 116. The information is accessed by at least one of the database 414 or the employee management system 118. The worker 412 may correspond to an associate of the shopping facility, a contractor to the shopping facility, and/or an individual associated with the shopping facility.

The control circuit 404 may be coupled to the wireless public access point 402 and the wireless secure access point 406. The control circuit 404 may be directly coupled to the wireless public access point 402 and the wireless secure access point 406. The control circuit 404 may be coupled to the network 120. The control circuit 404 may correspond to the control circuit 104 of FIG. 1 with the addition of the wireless public access point 402 and the wireless secure access point 406. The control circuit 404 may be configured to perform functionalities similar to those functionalities illustrated for the control circuit 104 in FIG. 1. For example, the control circuit 404 may estimate, based on a load over a period of time, a customer density pattern at a point in time within the period of time. The control circuit 404 may compare the estimated customer density pattern to point of sale data to determine if the estimated customer density pattern is justified or verified by the point of sale data. In yet another example, the control circuit 404 may determine a number of workers in a particular coverage zone based on a number of network enabled user devices accessing the wireless secure access point 406 from the particular coverage zone. As such, the control circuit 404 may determine whether the number of workers in the particular coverage zone is sufficient based on a predetermined threshold. The predetermined threshold may be based on, in part, the estimated customer density pattern.

The customer density pattern may also be estimated by the control circuit 404 based on a change in a customer density over time. A store worker of the plurality of workers may be alerted by the control circuit 404 when the estimated customer density exceeds a predetermined threshold. The store worker may also be alerted in response to determining by the control circuit 404 that a duration of the estimated customer density remains above the predetermined threshold. The control circuit 404 may output a signal to take an action when the duration exceeds a predetermined duration. Alternatively, or in addition, the control circuit 404 may output a second signal to take a second action based on the estimated customer density pattern. Actions corresponding to one or more signal may correspond to directing one or more workers of the shopping facility to ensure that customers are taken care off, alleviate long customer lines at checkout counter or customer service, order more products associated with one or more shelves, correlate estimated customer density pattern to sales data associated with the POS system 108, or any combination thereof. The actions may also include directing the one or more workers of the shopping facility to restock shelves or clean up when customer traffic is low.

In another implementation, the control circuit 404 may estimate a customer density based on a load of at least one of the wireless public access point 402 or the wireless secure access point 406. The control circuit 404 may also estimate the customer density pattern based on a change in the customer density over time. In response to the estimated customer density pattern in the coverage zone, the control circuit 404 may automatically create a task in the task scheduling system 110.

In some embodiments, estimating customer density over time can be misleading due to the fact that wireless access points may detect the wireless devices of store workers (e.g., store employees, third party employees providing various functions (stocking, delivering, etc.) to the store). The wireless devices of such workers if not accounted for, can result in misleading estimations of customer density. For example, a high density over time in one area of a shopping facility may be the result of several store workers performing a work function (clean up, inventory check, etc.) and not due to a high volume of customers. Thus, any triggered tasks to send customer service employees to assist could be unneeded. As described further below and in accordance with several embodiments, the control circuit 404 can estimate customer density by removing any detected wireless devices corresponding to store workers.

FIG. 5 illustrates a flow diagram of an exemplary method 500 of determining the customer density in the shopping facility in accordance with some embodiments. By one approach, the exemplary method 500 may be implemented in the control circuit 404 of FIG. 4. By another approach, the method 500 and/or one or more steps of the method 500 may optionally be implemented in and/or performed in cooperation with the control circuit 104 of FIG. 1. In step 510, data is received that corresponds to wireless traffic at a first wireless access point and a second wireless access point. Again, as explained herein, wireless traffic can include one or more types of data that can correlate to customer density including the number of devices detected, the number of devices having established connections, the data traffic occurring, and so on. The data may be received by the control circuit 404 of FIG. 4. The first wireless access point may correspond to the wireless public access point 402. The second wireless access point may correspond to the wireless secure access point 406.

In step 520, wireless traffic at the first wireless access point that corresponds to wireless traffic at the second wireless access point is identified. Wireless traffic generated by the network enabled user device 416 of FIG. 4 may correspond to wireless traffic at the wireless secure access point 406. The control circuit 404 may identify that the wireless traffic associated with the network enabled user device 416 at the wireless public access point 402 corresponds to the wireless traffic at the wireless secure access point 406. The data is processed, at step 530, to estimate a customer density in a coverage zone by at least subtracting from the wireless traffic at the first wireless access point the wireless traffic that corresponds to the wireless traffic at the second wireless access point. For example, the control circuit 404 may subtract the wireless traffic associated with the network enabled user device 416 from the wireless traffic at the wireless public access point 402. For example, based on signaling received from the wireless secure access point 406, the control circuit 404 may compare network enabled user devices associated with the wireless secure access point 406 to network enabled user devices associated with the wireless public access point 402 to determine if there are matches. Upon determining that there are matches, the control circuit 404 may subtract the wireless traffic associated with the matched network enabled user devices from the wireless traffic at the wireless public access point 402 prior to estimating a customer density in a coverage zone.

At step 540, a signaling to take an action is output based on the estimated customer density in the coverage zone. For example, the control circuit 404 may output a signaling to at least one of the POS system 108, the task scheduling system 110, the inventory system 112, the database 414, or the employee management system 118. The signaling may be associated with one or more actions that improves sales, efficiency and customer satisfaction in the shopping facility. For example, the signaling may be sent to the task scheduling system 110 to restock a shelf in aisle 1 with product A at a first time, product B at a second time, and product C at a third time. The signal may be communicated with the employee management system 118 to identify one or more workers available to restock the shelf at the specified time.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for determining customer density patterns in a shopping facility, the system comprising:
a wireless access point accessible by network enabled user devices and having a coverage zone in a shopping facility; and
a control circuit coupled to the wireless access point and configured to:
receive data corresponding to wireless traffic at the wireless access point;
process the data to determine a load of the wireless access point;
estimate, based on the load over a period of time, a customer density pattern in the coverage zone at a point in time within the period of time; and
output a signal to take an action based on at least the estimated customer density pattern in the coverage zone.

2. The system of claim 1, wherein the wireless access point is a first wireless access point having a first coverage zone in the shopping facility, and the system further comprises a second wireless access point coupled to the control circuit and only accessible by workers of the shopping facility, the second wireless access point having a second coverage zone that overlaps a least a portion of the first coverage zone, wherein the control circuit is further configured to:
receive data corresponding to wireless traffic at the second wireless access point;
identify wireless traffic at the first wireless access point that corresponds to wireless traffic at the second access point; and
subtract from the wireless traffic at the first access point the wireless traffic that corresponds to wireless traffic at the second access point to determine an estimated customer load of the first wireless access point;
estimate, based on the estimated customer load of the first wireless access point over a period of time, a customer density pattern in the first coverage zone at a point in time within the period of time.

3. The system of claim 1, wherein the control circuit is configured to estimate the customer density pattern by being configured to:
estimate a customer density in the coverage zone based on the load of the wireless access point; and
estimate the customer density pattern based on a change in the customer density over time in the coverage zone.

4. The system of claim 3, wherein a store worker is alerted when the estimated customer density in the coverage zone exceeds a predetermined threshold.

5. The system of claim 3, wherein the control circuit is further configured to:
determine a duration that the estimated customer density of the coverage zone remains above a predetermined threshold; and
output a second signal to take a second action when the duration exceeds a predetermined duration.

6. The system of claim 1, wherein the control circuit is further configured to automatically create a task in a task scheduling system in response to the estimated customer density pattern in the coverage zone.

7. The system of claim 1, wherein the control circuit is further configured to compare the estimated customer density pattern in the coverage zone to point of sale data to determine if the estimated customer density pattern in the coverage zone is justified by the point of sale data.

8. The system of claim 1, further comprising a plurality of wireless access points coupled to the control circuit and positioned throughout the shopping facility, the plurality of wireless access points having a plurality coverage zones.

9. The system of claim 8, wherein the plurality of coverage zones are minimally overlapping coverage zones.

10. The system of claim 8, wherein the control circuit is further configured to track a customer leaving one coverage zone associated with one wireless access point and entering a neighboring coverage zone associated with a neighboring wireless access point.

11. The system of claim 8, wherein the control circuit is configured to track customer flow in one or more directions based on changes in the estimated customer density patterns in the plurality of coverage zones over time.

12. A method for determining customer density patterns in a shopping facility, the method comprising:
receiving data from a wireless access point corresponding to wireless traffic at the wireless access point, the wireless access point being accessible by network enabled user devices and having a coverage zone in a shopping facility;
processing the data, using a control circuit, to determine a load of the wireless access point;
estimating, using the control circuit, based on the load over a period of time, a customer density pattern in the coverage zone at a point in time within the period of time; and
outputting a signal to take an action based on at least the estimated customer density pattern in the coverage zone.

13. The method of claim 12, wherein the wireless access point is a first wireless access point having a first coverage zone in the shopping facility, and the method further comprises
receiving data corresponding to wireless traffic at second wireless access point that is only accessible by workers of a shopping facility, the second wireless access point having a second coverage zone that overlaps a least a portion of the first coverage zone;
identifying wireless traffic at the first wireless access point that corresponds to wireless traffic at the second access point; and
subtracting from the wireless traffic at the first access point the wireless traffic that corresponds to wireless traffic at the second access point to determine an estimated customer load of the first wireless access point;
estimating, based on the estimated customer load of the first wireless access point over a period of time, a customer density pattern in the first coverage zone at a point in time within the period of time.

14. The method of claim 13, wherein estimating the customer density pattern in the first coverage zone comprises:
estimating a customer density in the first coverage zone based on the estimated customer load of the first wireless access point; and
estimating the customer density pattern in the first coverage zone based on a change in the customer density over time in the first coverage zone.

15. The method of claim 14, wherein a store worker is alerted when the estimated customer density in the first coverage zone exceeds a predetermined threshold.

16. The method of claim 12, further comprising automatically creating a task in a task scheduling system in response to the estimated customer density pattern in the coverage zone.

17. The method of claim 12, further comprising:
determining a duration that the estimated customer density of the coverage zone remains above a predetermined threshold; and
outputting a second signal to take a second action when the duration exceeds a predetermined duration.

18. The method of claim 12, further comprising comparing the estimated customer density pattern in the coverage zone to point of sale data to determine if the estimated customer density pattern in the coverage zone is justified by the point of sale data.

19. The method of claim 12, further comprising tracking a customer leaving one coverage zone associated with one wireless access point and entering a neighboring coverage zone associated with a neighboring wireless access point.

20. The method of claim 12, further comprising tracking customer flow in one or more directions based on changes in estimated customer density patterns over time in two or more coverage zones associated with two or more wireless access points.
